(19) United States
(12) Patent Application Publication
(10) Pub. No.: US 2026/0010063 A1
(43) Pub. Date: Jan. 8, 2026

(54) LIGHT SOURCE DEVICE AND PROJECTOR

(71) Applicant: SEIKO EPSON CORPORATION, Tokyo (JP)

(72) Inventor: Takuo YONEYAMA, AZUMINO-SHI, NAGANO-KEN (JP)

(21) Appl. No.: 19/256,363

(22) Filed: Jul. 1, 2025

(30) Foreign Application Priority Data
Jul. 2, 2024 (JP) 2024-106772

(51) Int. Cl. G03B 21/20; G03B 21/14

(52) U.S. Cl. CPC G03B 21/208; G03B 21/142

(57) ABSTRACT

A light source device in the present disclosure includes a light source unit, a first optical element configured to diffuse light emitted from the light source unit along a first axis orthogonal to an optical axis of the light to generate illumination light shaped like a band extending along the first axis, and a second optical element configured to collimate the illumination light emitted from the first optical element in a direction along the first axis, wherein the first optical element moves in a plane perpendicular to the optical axis.

The present application is based on, and claims priority from JP Application Serial Number 2024-106772, filed July 2, 2024, the disclosure of which is hereby incorporated by reference herein in its entirety.

### BACKGROUND

### 1. Technical Field

The present disclosure relates to a light source device and a projector.

### 2. Related Art

As a light source device used for a projector, a light source device that temporally scans a light modulation device such as a liquid crystal panel with light emitted from an optical element to thereby illuminate the light modulation device is proposed. JP-A-2007-225956 discloses a projector including a light source device including a light source lamp, a liquid crystal light valve, a polygonal mirror disposed between the light source device and the liquid crystal light valve, and a projection lens.

JP-A-2007-225956 is an example of the related art.

In the projector disclosed in JP-A-2007-225956, since the polygon mirror converges the light emitted from the light source device on the liquid crystal light valve while reflecting the light, it is difficult to make the illumination light extending in a band shape in a direction orthogonal to the scanning direction incident on the liquid crystal light valve.

### SUMMARY

In view of the problems described above, according to a first aspect of the present disclosure, there is provided a light source device including a light source unit, a first optical element configured to diffuse light emitted from the light source unit along a first axis orthogonal to an optical axis of the light to generate illumination light shaped like a band extending along the first axis, and a second optical element configured to collimate the illumination light emitted from the first optical element in a direction along the first axis, wherein the first optical element moves in a plane perpendicular to the optical axis.

According to a second aspect of the present disclosure, there is provided a projector including the light source device according to the first aspect, a light modulation device configured to modulate light incident from the light source device in accordance with image information, and a projection optical device configured to project the light modulated by the light modulation device.

### BRIEF DESCRIPTION OF THE DRAWINGS

FIG. 1 is a plan view of a projector according to a first embodiment viewed from a +Y side.

FIG. 2A is a diagram illustrating a behavior of illumination light when a transmissive optical element rotates.

FIG. 2B is a diagram illustrating the behavior of the illumination light when the transmissive optical element rotates.

FIG. 2C is a diagram illustrating the behavior of the illumination light when the transmissive optical element rotates.

FIG. 2D is a diagram illustrating the behavior of the illumination light when the transmissive optical element rotates.

FIG. 2E is a diagram illustrating the behavior of the illumination light when the transmissive optical element rotates.

FIG. 2F is a diagram illustrating the behavior of the illumination light when the transmissive optical element rotates.

FIG. 3 is a diagram illustrating a principle of reducing speckle noise.

FIG. 4 is a plan view showing a schematic configuration of a first optical element according to a first modified example viewed from the +Y side.

FIG. 5 is a plan view showing a schematic configuration of a first optical element according to a second modified example viewed from a -X side.

FIG. 6 is a diagram showing a schematic configuration of a first optical element according to a third modified example.

FIG. 7 is a perspective view showing a schematic configuration of a light source device according to a second embodiment.

### DESCRIPTION OF EMBODIMENTS

### First Embodiment

A first embodiment of the present disclosure will hereinafter be described using the drawings.

A projector according to the present embodiment is an example of a liquid crystal projector using a liquid crystal panel as a light modulation device.

In the following drawings, elements are drawn at different dimensional scales in some cases in order to make the elements enhance visibility. In the following descriptions of the drawings, an X-Y-Z orthogonal coordinate system will be used as needed. An X axis is an axis parallel to an illumination light axis of a light source device. The illumination light axis is defined as an axis along a principal ray of illumination light emitted from the light source device. A Z axis is an axis which is orthogonal to the X axis and extends along a rotational axis O of a transmissive optical element 41. A Y axis is an axis orthogonal to the X axis and the Z axis. The Z axis in the present embodiment corresponds to an example of a "first axis" in the present disclosure, and the Y axis in the present embodiment corresponds to an example of a "second axis" in the present disclosure.

Hereinafter, when describing a configuration and an arrangement of the members, one side (+X side) and the other side (-X side) in a direction along the X axis may be collectively referred to as an "X-axis direction", one side (+Y side) and the other side (-Y side) in a direction along the Y axis may be collectively referred to as a "Y-axis direction", and one side (+Z side) and the other side (-Z side) in a direction along the Z axis may be collectively referred to as a "Z-axis direction".

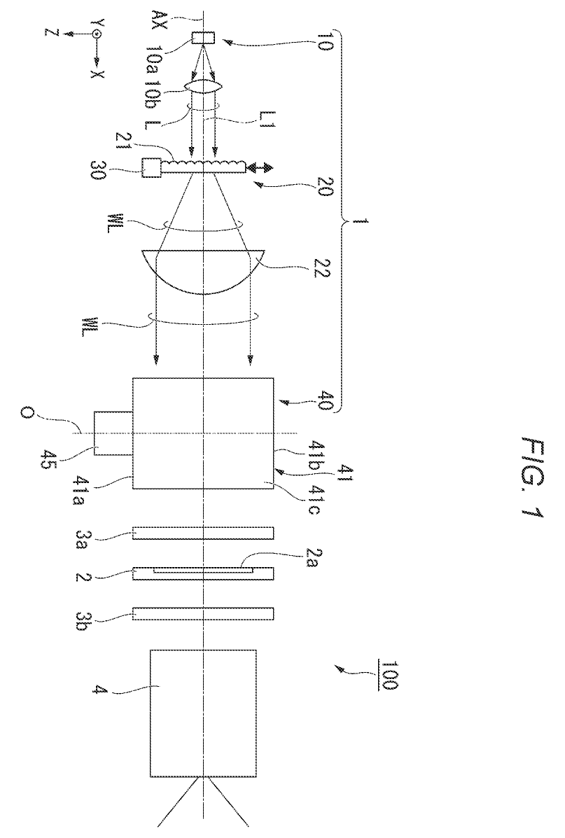

FIG. 1 is a plan view showing a schematic configuration of a projector according to the present embodiment viewed from the +Y side.

As shown in FIG. 1, a projector 100 according to the present embodiment includes a light source device 1, a light modulation device 2, an incident-side polarization plate 3a, an exit-side polarization plate 3b, and a projection optical device 4.

The light source device 1 includes a light source unit 10, a first optical element 20, a moving unit 30, a second optical element 22, and a light scanning unit 40.

The light source unit 10 includes a laser light emitting element 10a and a collimator lens 10b that collimates light L configured with laser light emitted from the laser light emitting element 10a. Therefore, the light source unit 10 emits white light L high in luminance configured with the laser light as parallel light. In the present embodiment, the cross-sectional shape perpendicular to the principal ray of the light L emitted by the light source unit 10 is, for example, a substantially square shape.

The first optical element 20 converts the light L emitted from the light source unit 10 into illumination light WL shaped like a band.

The first optical element 20 diffuses the light L emitted from the light source unit 10 along the Z axis to generate the illumination light WL shaped like a band extending along the Z axis. That is, the first optical element 20 diffuses the light L in the Z-axis direction orthogonal to an optical axis L1 of the light L and enlarges a luminous flux width of the light L in the Z-axis direction. In the present embodiment, the optical axis L1 of the light L emitted from the light source unit 10 coincides with the illumination light axis AX of the light source device 1.

The first optical element 20 of the present embodiment is a lenticular lens.

The first optical element 20 includes a plurality of lenses 21 arranged in the Z-axis direction. Each of the lenses 21 is a cylindrical convex lens having positive power in the Z-axis direction and no power in the Y-axis direction. Therefore, the lenses 21 divide the light L incident from the light source unit 10 into a plurality of pencils of light in the Z-axis direction. Each of the pencils of light converges on the lens focal point and then diverges in the Z-axis direction. The light L incident from the light source unit 10 passes through each of the lenses 21 without changing the traveling direction in the Y-axis direction in which the lens 21 has no power. In this way, the first optical element 20 diffuses the light L emitted from the light source unit 10 in the Z-axis direction to generate the illumination light WL shaped like a band elongated in the Z-axis direction.

The second optical element 22 collimates the illumination light WL emitted from the first optical element 20 in the Z-axis direction. The second optical element 22 is a cylindrical convex lens having positive power in the Z-axis direction and no power in the Y-axis direction.

The light L emitted from the light source unit 10 is transmitted through the first optical element 20 and the second optical element 22 to thereby be converted into the illumination light WL configured with parallel light having a luminous flux width in the Z-axis direction expanded as compared with that before entering the first optical element 20. A rate of change (a degree of diffusion) of the luminous flux width in the Z-axis direction in the first optical element 20 can be adjusted by, for example, adjusting the optical characteristics such as the curvature and the refractive index of each of the lenses 21 constituting the lenticular lens.

The first optical element 20 is made movable in a Y-Z plane orthogonal to the optical axis L1 and the illumination light axis AX. The light source device 1 according to the present embodiment moves the first optical element 20 in the Z-axis direction with the moving unit 30. The moving unit 30 in the present embodiment is a voice coil motor. In this way, the first optical element 20 can smoothly perform a swinging operation of reciprocating along the Z axis. The light source device 1 according to the present embodiment can reduce interference fringes and speckle noise in the illumination light WL as described later by swinging the first optical element 20 in the Z-axis direction.

The light scanning unit 40 scans an illumination target area in the Y axis direction with the illumination light WL incident from the second optical element 22. Specifically, the light scanning unit 40 scans, in the Y-axis direction, a light modulation area 2a of the light modulation device 2 disposed in the illumination target area with the illumination light WL shaped like a band extending in the Z-axis direction. Therefore, the light scanning unit 40 can efficiently illuminate the entire light modulation area 2a by scanning the light modulation area 2a in a traverse direction thereof with the illumination light WL shaped like a band.

In the present embodiment, the light scanning unit 40 scans the light modulation device 2 with the illumination light WL along the traverse direction of the illumination light WL. According to this configuration, since the illumination light WL and the light modulation area 2a of the light modulation device 2 can be aligned with each other with reference to the longitudinal direction of the illumination light WL, it becomes easy to align the light scanning unit 40, which emits the illumination light WL, and the light modulation device 2 with each other. Therefore, combinability of the light source device 1 can be improved.

The light scanning unit 40 includes the transmissive optical element 41 and a rotary drive unit 45.

The transmissive optical element 41 is formed of a light transmissive member rotatably supported. The transmissive optical element 41 is made rotatable around a rotational axis O extending along the Z-axis direction. The transmissive optical element 41 is coupled to the rotary drive unit 45 including a motor and so on. The transmissive optical element 41 is driven by the rotary drive unit 45 to rotate around the rotational axis O.

As a glass material of the light transmissive member constituting the transmissive optical element 41, a light transmissive material such as optical glass such as BK7, quartz, or resin is used. The transmissive optical element 41 in the present embodiment has a first surface 41a and a second surface 41b that cross the rotational axis O, and four side surfaces 41c that are in perpendicular contact with the first surface 41a and the second surface 41b. That is, the transmissive optical element 41 has a square prismatic shape having six planar surfaces including the first surface 41a, the second surface 41b, and the four side surfaces 41c. A cross-sectional shape of the transmissive optical element 41 cut by a plane perpendicular to the rotational axis O is a square shape. That is, the four side surfaces 41c have the same area as each other, and any pair of side surfaces opposed to each other are parallel to each other. The rotational axis O coincides with the center of the transmissive optical element 41 having a square shape.

The transmissive optical element 41 transmits the illumination light WL emitted from the second optical element 22 while rotating around the rotational axis O. Therefore, the side surface from which the illumination light WL emitted from the second optical element 22 enters the transmissive optical element 41 is not uniquely fixed but changes with time. Similarly, the side surface from which the illumination light WL incident on the transmissive optical element 41 is emitted to the outside space is not uniquely fixed, but changes with time. In the transmissive optical element 41, the side surface which the illumination light WL emitted from the second optical element 22 is incident on is referred to as a "plane of incidence". The side surface that emits the illumination light WL incident on the plane of incidence is referred to as an "exit surface". In this case, the plane of incidence and the exit surface change with time, and are any of the two side surfaces parallel to each other out of the four side surfaces 41c.

In the present specification, when two surfaces of the transmissive optical element 41 are referred to as surfaces parallel to each other, "parallel" refers to a case where the angle between the two surfaces falls within a range of 0±5 degrees in consideration of the processing accuracy of the glass material constituting the light transmissive member, an allowable range of the parallelism of the light, and so on.

In the case of the present embodiment, the transmissive optical element 41 has the four side surfaces 41c, but the number of side surfaces is not necessarily required to be four, but is desirably 2×m (m is a natural number no smaller than 2). That is, the number of side surfaces is desirably an even number such as six or eight. When the number of side surfaces is the even number, all the side surfaces each become parallel to the side surface opposed to that side surface, and there is no side surface which is not parallel to any of the side surfaces. Thus, stray light rarely occurs in the transmissive optical element 41, and the light use efficiency can be increased.

The light modulation device 2 is disposed at the light exit side of the second optical element 22 on the illumination light axis AX. The light modulation device 2 modulates the illumination light WL emitted from the second optical element 22 in accordance with image information to form image light. A transmissive liquid crystal panel is used as the light modulation device 2. The liquid crystal panel may or may not include a color filter. When the liquid crystal panel includes the color filter, the projector 100 capable of color display can be achieved. When the liquid crystal panel does not include the color filter, the projector 100 capable of monochrome display can be achieved. A twisted nematic (TN) method, a vertical alignment (VA) method, an in-plane switching (IPS) method, and so on may be used as a method of driving the liquid crystal panel, and the method is not particularly limited.

The incident-side polarization plate 3a is disposed at the light incident side of the light modulation device 2 on the illumination light axis AX. The exit-side polarization plate 3b is disposed at the light exit side of the light modulation device 2 on the illumination light axis AX. The transmission axes of the incident-side polarization plate 3a and the exit-side polarization plate 3b are orthogonal to each other.

The incident-side polarization plate 3a transmits a linearly-polarized component in a specific direction out of the illumination light WL emitted from the light source unit 10 toward the light modulation device 2. The exit-side polarization plate 3b transmits linearly-polarized light in a specific direction emitted from the light modulation device 2 toward the projection optical device 4. In the case of the present embodiment, since the light source unit 10 uses the laser light emitting element 10a, the light L incident thereon from the light source unit 10 is linearly-polarized light. However, in the transmissive optical element 41, an amount of light absorbed by the light transmissive member increases as an amount of light transmitted through the light transmissive member increases, and thermal strain may be generated in the light transmissive member in some cases. In this case, the polarization direction of the light L emitted from the light source unit 10 is disturbed, and the linearly-polarized light incident on the light transmissive member is converted into elliptically-polarized light and is then emitted from the light transmissive member. In the case of the present embodiment, by providing the incident-side polarization plate 3a, even when the polarization direction of the light L is disturbed, it is possible to make the linearly-polarized component in the specific direction incident on the light modulation device 2.

Note that when quartz, which is a glass material low in Young's modulus and a thermal expansion coefficient, is used as the transmissive optical element 41, disturbance in the polarization direction less likely occurs, and thus the incident-side polarization plate 3a disposed at the light incident side of the light modulation device 2 can be omitted.

The projection optical device 4 is configured with a plurality of projection lenses. The projection optical device 4 projects the image light modulated by the light modulation device 2 toward a projection target surface such as a screen. Thus, an image is displayed on the projection target surface.

Subsequently, the behavior of the illumination light WL by the transmissive optical element 41 of the light scanning unit 40 will be described.

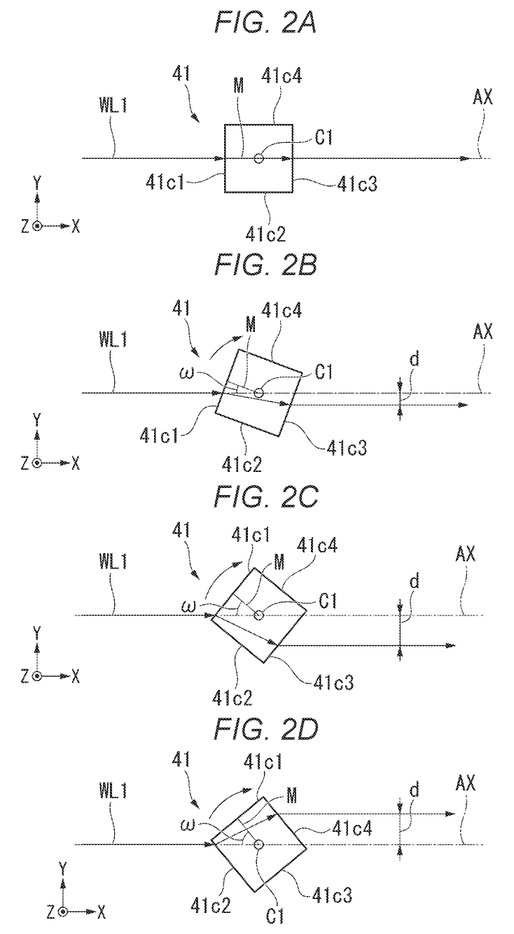

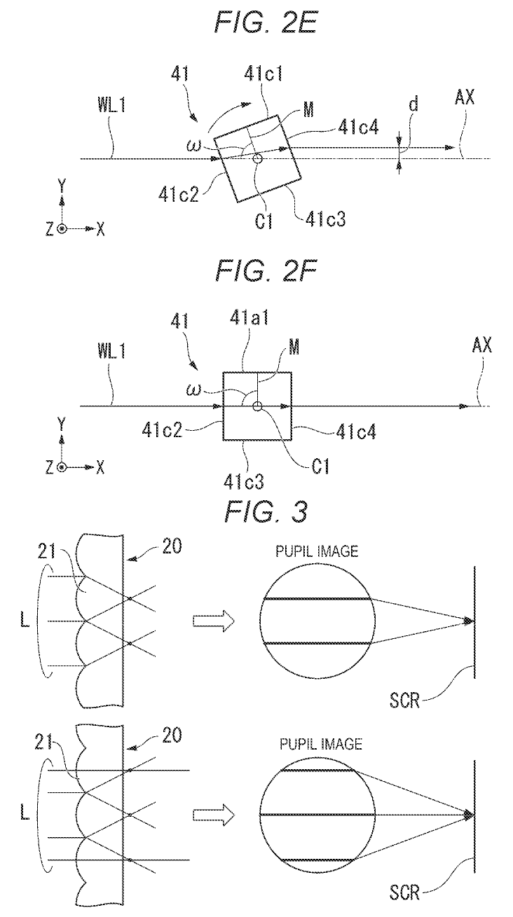

FIGS. 2A to 2F are schematic diagrams illustrating the behavior of the illumination light WL when the transmissive optical element 41 rotates. In this example, the transmissive optical element 41 rotates clockwise around the rotational axis O when viewed from the +Z side, and FIGS. 2A to 2F show the states in which time elapses from the state shown in FIG. 2A toward the state shown in FIG. 2F. In FIGS. 2A to 2F, illustration of the rotary drive unit 45 is omitted.

In FIGS. 2A to 2F, an angle between a straight line M passing through the rotational axis O and orthogonal to a side surface 41c1 of the transmissive optical element 41 and the illumination light axis AX is defined as a rotation angle ω of the transmissive optical element 41. Further, although the illumination light WL actually has a predetermined luminous flux width in the Z-axis direction, consideration will be made here focusing attention on the behavior of a light beam WL1 as a principal ray propagating along the illumination light axis AX.

FIG. 2A shows an initial state of the transmissive optical element 41. That is, the transmissive optical element 41 does not rotate, the straight line M overlaps the illumination light axis AX, and the rotation angle ω is 0 degree. In this case, since the light beam WL1 perpendicularly enters the side surface 41c1, the light beam WL1 is not refracted at the side surface 41c1 but travels inside the transmissive optical element 41 along the illumination light axis AX. Then, the light beam WL1 also perpendicularly enters the side surface 41c3, which is parallel to the side surface 41c1. Therefore, the light beam WL1 is not refracted at the side surface 41c3, but is emitted from the transmissive optical element 41, and then travels along the illumination light axis AX.

Then, as shown in FIG. 2B, when the transmissive optical element 41 rotates by the rotation angle ω, the light beam WL1 is incident on the side surface 41c1 at an incidence angle equal to the rotation angle ω. Therefore, the light beam WL1 is refracted in the direction (+Z side) shown in the drawing and then travels inside the transmissive optical element 41. Then, since the light beam WL1 is also incident on the side surface 41c3 at a predetermined incidence angle, the light beam WL1 is refracted at the side surface 41c3 and is then emitted from the transmissive optical element 41. On this occasion, since the side surface 41c1 and the side surface 41c3 are parallel to each other, the incidence angle of the light beam WL1 incident on the side surface 41c1 and the incidence angle of the light beam WL1 incident on the side surface 41c3 are equal to each other, and the refraction angle of the light beam WL1 incident on the side surface 41c1 and the refraction angle of the light beam WL1 emitted from the side surface 41c3 are opposite in sign and equal in absolute value. Thus, the refraction angle of the light beam WL1 incident on the side surface 41c1 and the refraction angle of the light beam WL1 emitted from the side surface 41c3 are canceled each other out. As a result, the light beam WL1 travels in parallel to the illumination light axis AX at a position displaced from the illumination light axis AX by a displacement amount d toward the +Z side.

Then, as shown in FIG. 2C, when the rotation angle ω of the transmissive optical element 41 becomes larger than that shown in FIG. 2B, the incidence angle of the light beam WL1 becomes larger, and the refraction angle becomes larger. Therefore, the displacement amount d of the light beam WL1 from the illumination light axis AX becomes larger than that shown in FIG. 2B. Further, the state in which the light beam WL1 travels in parallel to the illumination light axis AX is constantly maintained. When the rotation angle ω is between 0 degree and 45 degrees, the displacement amount d monotonously increases as the rotation angle ω increases.

Then, as shown in FIG. 2D, when the rotation angle ω of the transmissive optical element 41 exceeds 45 degrees, the plane of incidence of the light beam WL1 changes from the side surface 41c1 to the side surface 41c2. On this occasion, the light beam WL1 is refracted at the side surface 41c2, but the refraction direction changes from the direction in the period on and before the state shown in FIG. 2C, and the light beam WL1 is refracted toward the direction (-Z side) shown in the drawing. Further, although the exit surface of the light beam WL1 also changes from the side surface 41c3 to the side surface 41c4, since the side surface 41c2 and the side surface 41c4 are parallel to each other, the relationship in which the refraction angle of the light beam WL1 incident on the side surface 41c2 and the refraction angle of the light beam WL1 emitted from the side surface 41c4 are canceled each other out remains unchanged from that in the period on and before the state shown in FIG. 2C. As a result, the light beam WL1 travels in parallel to the illumination light axis AX at a position displaced from the illumination light axis AX by a displacement amount d toward the -Z side.

Then, as shown in FIG. 2E, when the rotation angle ω of the transmissive optical element 41 becomes larger than that shown in FIG. 2D, the incidence angle of the light beam WL1 becomes smaller and the refraction angle becomes smaller. Therefore, the displacement amount d of the light beam WL1 from the illumination light axis AX becomes smaller than that shown in FIG. 2D. As described above, when the rotation angle ω is between 45 degrees and 90 degrees, the displacement amount d monotonously decreases as the rotation angle ω increases.

Then, as shown in FIG. 2F, when the rotation angle ω of the transmissive optical element 41 reaches 90 degrees, the plane of incidence changes from the side surface 41c1 as the initial state to the side surface 41c2, but the behavior of the light beam WL1 is the same as that in the initial state shown in FIG. 2A.

As described above, when the plane of incidence and the exit surface of the transmissive optical element 41 are parallel to each other, the traveling direction of the light beam WL1 does not change regardless of the rotation angle ω of the transmissive optical element 41, and the light beam WL1 is translated in a direction parallel to the illumination light axis AX as the time elapses. When the rotation angle ω is 0 degree, the displacement amount d of the light beam WL1 is 0, and when the rotation angle ω is between 0 degree and 45 degrees, the displacement amount d increases toward either one of the +Z side and the -Z side. At the moment when the rotation angle ω exceeds 45 degrees, the displacement direction is reversed while keeping the absolute value of the displacement amount d the same, when the rotation angle ω is between 45 degrees and 90 degrees, the displacement amount d decreases, and when the rotation angle ω reaches 90 degrees, the displacement amount d becomes 0. After the rotation angle ω exceeds 90 degrees, the behavior described above is repeated. Therefore, when the transmissive optical element 41 makes one revolution, the displacement amount d of the light beam WL1 repeats the cycle described above four times. The displacement amount of the light beam WL1 can be appropriately set by adjusting parameters such as the refractive index and the size of the transmissive optical element 41.

The illumination light WL incident from the light scanning unit 40 illuminates the light modulation area 2a of the light modulation device 2 to perform scanning in the Y-axis direction. Therefore, since the illumination lights WL are superimposed on each other in the Y-axis direction, it is possible to enhance the uniformity of the intensity distribution of the light modulation area 2a.

As described above, in the light source device 1 according to the present embodiment, the first optical element 20 formed of the lenticular lens includes the plurality of lenses 21. Since the lenses 21 have the same shape, the first optical element 20 has a regular uneven structure. It is known that the light transmitted through the regular uneven structure interferes with each other to thereby generate interference fringes, and when such interference fringes are generated in the projection image, the image quality of the visually recognized image is significantly deteriorated.

In contrast, in the light source device 1 according to the present embodiment, the moving unit 30 swings the first optical element 20 in the Z-axis direction. When the first optical element 20 moves in the Z-axis direction, the position at which the light L emitted from the light source unit 10 is transmitted through the first optical element 20 temporally changes. Therefore, the interference fringes of the light L transmitted through the first optical element 20 temporally change.

In the case of the present embodiment, since the first optical element 20 moves in the arrangement direction of the lenses 21, the uneven structure through which the light L is transmitted efficiently changes, and the temporal change of the light L can be further increased. Therefore, since the interference fringes of the illumination light WL are time-averaged, it is possible to make it difficult to visually recognize the interference fringes in the projection image.

Further, in the light source device 1 according to the present embodiment, since the light L emitted from the light source unit 10 is coherent light, there is a possibility that speckles are generated in the projection image. In the related art, a method of reducing speckle noise of a projection image by shaking a screen surface on which an image of a projector is projected is known. However, since the screen is large in general, it is very difficult to realize a configuration in which the screen surface is shaken.

In contrast, in the light source device 1 according to the present embodiment, the speckle noise of the projection image can be reduced by swinging the first optical element 20.

Here, the principle of reducing the speckle noise by swinging the first optical element 20 will be described with reference to FIG. 3.

When the position at which the light L emitted from the light source unit 10 is transmitted through the first optical element 20 temporally changes, the image formed by the light L transmitted through the first optical element 20 temporally changes, as shown in FIG. 3. The image of the light L transmitted through the first optical element 20 is optically conjugate with a pupil image of the projection optical device 4. That is, when the first optical element 20 moves, the pupil image of the projection optical device 4 temporally changes. When the pupil image of the projection optical device 4 changes, the speckle pattern formed on the screen SCR also changes since a variation in the angle of the light incident on the screen SCR is different. In the past, it is known that the larger the number of speckle patterns formed on the screen SCR is, the more the speckle noise can be reduced.

As described above, according to the light source device 1 in the present embodiment, since the first optical element 20 is moved, the speckle noise can be reduced by sequentially forming different speckle patterns on the screen SCR.

As described above, the light source device 1 according to the present embodiment includes the light source unit 10, the first optical element 20 that diffuses the light L emitted from the light source unit 10 along the Z axis orthogonal to the optical axis L1 to generate the illumination light WL shaped like a band extending along the Z axis, and the second optical element 22 that collimates the illumination light WL emitted from the first optical element 20 in the direction along the Z axis. The first optical element 20 is movable in the Y-Z plane perpendicular to the optical axis L1.

According to the light source device 1 in the present embodiment, it is possible to convert the light L emitted from the light source unit 10 into the illumination light WL shaped like a band elongated in the Z-axis direction with the first optical element 20 and the second optical element 22. The illumination light WL extends in a band shape in a direction orthogonal to the light scanning direction by the light scanning unit 40. Therefore, the light scanning unit 40 can efficiently illuminate the entire light modulation area 2a of the light modulation device 2 with the illumination light WL.

The first optical element 20 in the present embodiment has a regular uneven structure to thereby generate interference fringes in the illumination light WL, but in the light source device 1 according to the present embodiment, the interference fringes of the light L transmitted through the first optical element 20 can be temporally changed by swinging the first optical element 20 with the moving unit 30. Thus, by time-averaging the interference fringes of the illumination light WL, it is possible to make it difficult to visually recognize the interference fringes in the projection image.

Further, in the present embodiment, since the light L emitted from the light source unit 10 is coherent light, there is a possibility that speckles are generated in the projection image, but the light source device 1 in the present embodiment can reduce speckle noise in the projection image by swinging the first optical element 20.

According to the projector 100 of the present embodiment, since the illumination light WL emitted from the light source device 1 efficiently illuminates the light modulation area 2a of the light modulation device 2, a bright image can be projected. Further, it is possible to project a high-quality image in which interference fringes and speckle noise in the projection image are suppressed.

### First Modified Example

A first modified example of the first embodiment will hereinafter be described.

The present modified example is different in configuration of the first optical element from the first embodiment. Note that members common to the present modified example and the first embodiment are denoted by the same reference numerals to omit the detailed description thereof.

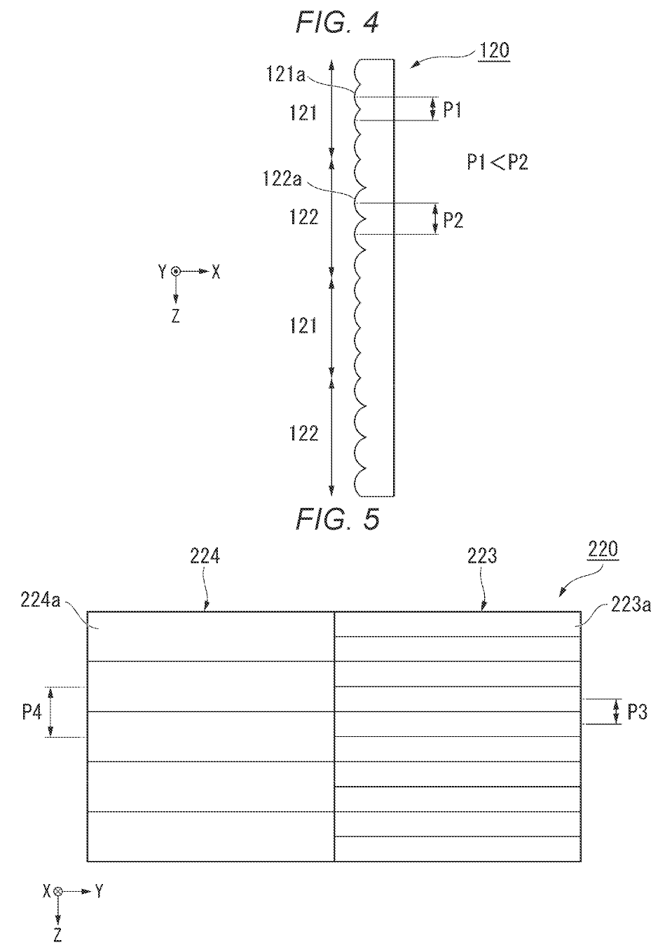

FIG. 4 is a plan view illustrating a schematic configuration of a first optical element 120 in the present modified example viewed from the +Y side. As illustrated in FIG. 4, the first optical element 120 in the present modified example includes a plurality of first lens groups 121 and a plurality of second lens groups 122 alternately arranged in the Z-axis direction.

The first lens group 121 includes a plurality of first lenses 121a. Each of the first lenses 121a is a cylindrical convex lens having positive power in the Z-axis direction and no power in the Y-axis direction.

The second lens group 122 includes a plurality of second lenses 122a. Each of the second lenses 122a is a cylindrical convex lens having positive power in the Z-axis direction and no power in the Y-axis direction.

The first lens 121a has a first curvature in the Z-axis direction, and the second lens 122a has a second curvature different from the first curvature in the Z-axis direction. In the case of the present modified example, the first curvature of the first lens 121a is lower than the second curvature of the second lens 122a. Further, a first arrangement pitch P1 of the first lenses 121a adjacent to each other is narrower than a second arrangement pitch P2 of the second lenses 122a adjacent to each other.

The curvatures of the first lens 121a and the second lens 122a are adjusted such that the diffusion angle of the light L transmitted through each of the first lenses 121a and the diffusion angle of the light L transmitted through each of the second lenses 122a are constant.

In the first optical element 120 in the present modified example, since the first lens group 121 and the second lens group 122 each have a regular uneven structure, the light L transmitted through the first lens group 121 and the second lens group 122 generates interference fringes. Also in the present modified example, the interference fringes of the light L transmitted through the first optical element 120 can be temporally changed by swinging the first optical element 120 in the Z-axis direction.

In the case of the present modified example, since the first lens group 121 and the second lens group 122 have the respective arrangement pitches P1, P2 different from each other, the interference fringes by the first lens group 121 and the interference fringes by the second lens group 122 are different from each other. Therefore, according to the present modified example, by increasing the degree of temporal change of the interference fringes of the light L transmitted through the first optical element 120, it is possible to make it more difficult to visually recognize the interference fringes in the projection image.

Further, also in the first optical element 120 in the present modified example, the speckle noise of the projection image can be reduced by swinging the first optical element 120.

### Second Modified Example

A second modified example of the first embodiment will hereinafter be described.

The present modified example is different in configuration of the first optical element from the first embodiment. Note that members common to the present modified example and the first embodiment are denoted by the same reference numerals to omit the detailed description thereof.

FIG. 5 is a plan view illustrating a schematic configuration of a first optical element 220 in the present modified example viewed from the -X side. As illustrated in FIG. 5, the first optical element 220 in the present modified example includes a third lens group 223 and a fourth lens group 224 arranged side by side in the Y-axis direction.

The third lens group 223 includes a plurality of third lenses 223a. Each of the third lenses 223a is a cylindrical convex lens having positive power in the Z-axis direction and no power in the Y-axis direction.

The fourth lens group 224 includes a plurality of fourth lenses 224a. Each of the fourth lenses 224a is a cylindrical convex lens having positive power in the Z-axis direction and no power in the Y-axis direction.

The third lens 223a has a third curvature in the Z-axis direction, and the fourth lens 224a has a fourth curvature different from the third curvature in the Z-axis direction. In the case of the present modified example, the third curvature of the third lens 223a is lower than the fourth curvature of the fourth lens 224a. A third arrangement pitch P3 of the third lenses 223a adjacent to each other is narrower than a fourth arrangement pitch P4 of the fourth lenses 224a adjacent to each other.

The curvatures of the third lens 223a and the fourth lens 224a are adjusted such that the diffusion angle of the light L transmitted through each of the third lenses 223a and the diffusion angle of the light L transmitted through each of the fourth lenses 224a are constant.

In the first optical element 220 in the present modified example, since the third lens group 223 and the fourth lens group 224 each have a regular uneven structure, the light L transmitted through the third lens group 223 and the fourth lens group 224 generates interference fringes. Also in the present modified example, the interference fringes of the light L transmitted through the first optical element 220 can be temporally changed by swinging the first optical element 220 in the Z-axis direction. In addition, speckle noise of the projection image can be reduced.

Since the third lens group 223 and the fourth lens group 224 have respective arrangement pitches P3, P4 different from each other, the interference fringes by the third lens group 223 and the interference fringes by the fourth lens group 224 are different from each other. Therefore, according to the present modified example, by increasing the degree of temporal change of the interference fringes of the light L transmitted through the first optical element 220, it is possible to make it more difficult to visually recognize the interference fringes in the projection image.

Further, the first optical element 220 of the present modified example can be easily manufactured by bonding the lenticular lens formed of the third lens group 223 and the lenticular lens formed of the fourth lens group 224 in the Y-axis direction.

When different lens groups are disposed in the Y-axis direction as in the first optical element 220 of the present modified example, the first optical element 220 may be moved in the Y-Z plane perpendicular to the optical axis L1 in, for example, the Y-axis direction instead of the Z-axis direction.

### Third Modified Example

A third modified example of the first embodiment will hereinafter be described.

The present modified example is different in configuration of the first optical element from the first embodiment. Note that members common to the present modified example and the first embodiment are denoted by the same reference numerals to omit the detailed description thereof.

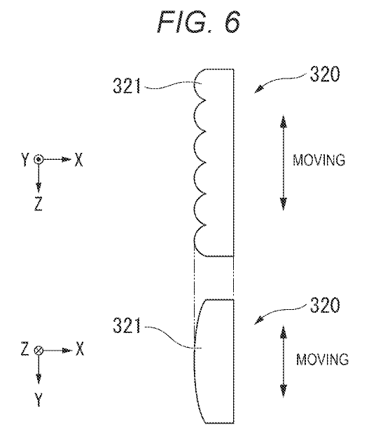

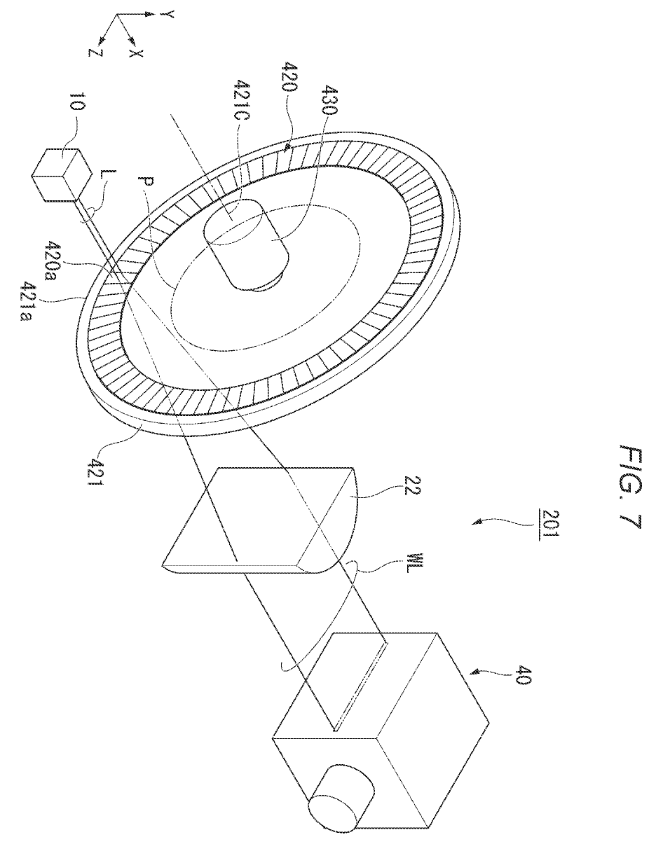

FIG. 6 is a diagram illustrating a schematic configuration of a first optical element 320 in the present modified example. An upper part of FIG. 6 is a plan view of the first optical element 320 viewed from the +Y side, and the lower part of FIG. 6 is a plan view of the first optical element 320 viewed from the -Z side.

As shown in FIG. 6, the first optical element 320 in the present modified example includes a plurality of lenses 321 arranged in the Z-axis direction. Each of the lenses 321 is a toric lens having a positive power in both the Y-axis direction and the Z-axis direction wherein the power in the Y-axis direction and the power in the Z-axis direction are different from each other.

The lenses 321 divide the light L incident from the light source unit 10 into a plurality of pencils of light in the Z-axis direction. Each of the pencils of light converges on the lens focal point and then diverges in the Z-axis direction and the Y-axis direction. The first optical element 320 diffuses the light L emitted from the light source unit 10 not only in the Z-axis direction but also in the Y-axis direction.

The first optical element 320 in the present modified example has a first diffusion angle along the Z-axis direction and a second diffusion angle along the Y-axis direction, and the second diffusion angle is smaller than the first diffusion angle. In the present modified example, in each of the lenses 321, the curvature in the Z-axis direction is lower than the curvature in the Y-axis direction.

Therefore, the first optical element 320 according to the present modified example greatly diffuses the light L emitted from the light source unit 10 in the Z-axis direction and less greatly diffuses the light L in the Y-axis direction than in the Z-axis direction to generate the illumination light WL shaped like a band elongated in the Z-axis direction. The illumination light WL generated in the present modified example has a band shape smaller in difference between the long side and the short side than that in the first embodiment.

In the present modified example, the first optical element 320 moves in two directions, that is, the direction along the Z axis and the direction along the Y axis. In the present modified example, the moving unit 30 swings the first optical element 320 in two directions, that is, the Z-axis direction and the Y-axis direction.

According to the first optical element 320 in the present modified example, it is possible to further increase the temporal change in the interference fringes of the light L transmitted through the first optical element 320 by moving the first optical element 320 in the two directions, that is, the Z-axis direction and the Y-axis direction. Therefore, it is possible to more effectively reduce interference fringes and speckle noise in the projection image.

### Second Embodiment

A second embodiment of the present disclosure will hereinafter be described.

The present embodiment is different in the configuration of the light source device from the first embodiment. Note that members common to the present modified example and the first embodiment are denoted by the same reference numerals to omit the detailed description thereof.

FIG. 7 is a perspective view showing a schematic configuration of the light source device 201 in the present embodiment. As shown in FIG. 7, the light source device 201 in the present embodiment includes the light source unit 10, a first optical element 420, a substrate 421, a drive unit 430, the second optical element 22, and the light scanning unit 40.

The first optical element 420 is provided to the substrate 421, and the substrate 421 is a disk. The first optical element 420 is disposed in an annular shape (a ring shape) along a circumferential direction of the substrate 421. The first optical element 420 is a lenticular lens and includes a plurality of lenses 420a arranged in the circumferential direction of the substrate 421. Each of the lenses 420a is a cylindrical convex lens having positive power in the circumferential direction and no power in the radial direction. Each of the lenses 420a has a substantially trapezoidal planar shape in a plan view in the X-axis direction. The drive unit 430 is a motor that rotates the substrate 421 with the center 421C of the substrate 421 as a rotational axis.

Here, the closer to the center 421C of the substrate 421 the position at which the first optical element 420 is disposed is, the lower the curvature of the first optical element 420 becomes. Then, the light L which is transmitted through each of the lenses 420a of the first optical element 420 to thereby be diffused is distorted in a U shape, and the distortion of the illumination light WL also increases.

In contrast, the first optical element 420 in the present embodiment is disposed closer to an outer peripheral edge 421a than to a midpoint P between the center 421C of the substrate 421 and the outer peripheral edge 421a of the substrate 421 in the radial direction of the substrate 421. According to this configuration, since the curvature of the first optical element 420 can be increased, the distortion generated in the light L transmitted through each the lenses 420a of the first optical element 420 can be reduced. Therefore, it is possible to suppress the distortion to generate the illumination light WL extending in a band shape in the Z-axis direction.

As described above, according to the light source device 201 in the present embodiment, the light L emitted from the light source unit 10 can be diffused along the Z axis with the first optical element 420 to generate the illumination light WL shaped like a band extending along the Z axis. Further, the light source device 201 rotates the substrate 421 to thereby move the first optical element 420 in the circumferential direction in a plane orthogonal to the optical axis L1. Accordingly, the position where the light L emitted from the light source unit 10 is transmitted through the first optical element 420 temporally changes, and the interference fringes in the light L can be temporally changed. In the case of the present embodiment, since the first optical element 420 rotates in the arrangement direction of the lenses 420a, the uneven structure through which the light L is transmitted efficiently changes, and the temporal change of the light L can be further increased. Therefore, by time-averaging the interference fringes of the illumination light WL, it is possible to make it difficult to visually recognize the interference fringes in the projection image.

Further, also in the light source device 201 according to the present embodiment, the speckle noise in the projection image can be reduced by rotating the first optical element 420.

Note that the technical scope of the present disclosure is not limited to the embodiment described above, and various modifications can be made therein without departing from the spirit and scope of the present disclosure.

In addition, the specific descriptions of the shapes, the numbers, the arrangements, the materials, and the like of the elements of the light source device and the projector are not limited to those in the embodiments described above, and can be changed as appropriate.

For example, in the first embodiment, there is cited when the lenticular lens is used as the first optical element 20 that diffuses the light L emitted from the light source unit 10 in the Z-axis direction as an example, but the first optical element in the present disclosure may be a diffusion plate having anisotropy in diffusion characteristics having diffusivity in the Z-axis direction but not having optical diffusivity in the Y-axis direction.

The present disclosure will be summarized below in the form of appendices.

### Appendix 1

A light source device including

a light source unit,

a first optical element configured to diffuse light emitted from the light source unit along a first axis orthogonal to an optical axis of the light to generate illumination light shaped like a band extending along the first axis, and

a second optical element configured to collimate the illumination light emitted from the first optical element in a direction along the first axis, wherein

the first optical element moves in a plane perpendicular to the optical axis.

According to the light source device having this configuration, the light emitted from the light source unit can be converted into the illumination light shaped like a band elongated in the first axis direction with the first optical element and the second optical element. The first optical element has a regular uneven structure to thereby generate the interference fringes in the illumination light, but in the light source device having this configuration, the interference fringes in the light transmitted through the first optical element can be temporally changed by moving the first optical element. This makes it difficult to visually recognize the interference fringes by time-averaging the interference fringes in the illumination light.

### Appendix 2

The light source device according to Appendix 1, wherein

the first optical element is a lenticular lens.

According to this configuration, it is possible to favorably generate the illumination light shaped like a band elongated in the first axis direction.

### Appendix 3

The light source device according to Appendix 2, wherein

the first optical element includes a first lens group including a plurality of first lenses having a first curvature, and a second lens group including a plurality of second lenses having a second curvature different from the first curvature,

the first lens group and the second lens group are disposed in a direction along the first axis, and

an arrangement pitch of the plurality of first lenses of the first lens group is different from an arrangement pitch of the plurality of second lenses of the second lens group.

According to this configuration, since the first lens group and the second lens group have the respective arrangement pitches different from each other, interference fringes by the first lens group and interference fringes by the second lens group are different from each other. Therefore, by increasing the degree of temporal change of the interference fringes of the light transmitted through the first optical element, the interference fringes in the illumination light can be made more difficult to visually recognize.

### Appendix 4

The light source device according to Appendix 1 or 2, wherein

the first optical element also diffuses the light emitted from the light source unit in a direction along a second axis orthogonal to the first axis,

the first optical element has a first diffusion angle along the first axis and a second diffusion angle along the second axis, and

the second diffusion angle is smaller than the first diffusion angle.

According to this configuration, it is possible to generate the illumination light shaped like a desired band by diffusing the light emitted from the light source unit in two directions.

### Appendix 5

The light source device according to Appendix 4, wherein

the first optical element moves in two directions respectively along the first axis and the second axis.

According to this configuration, by swinging the first optical element in the two directions, the temporal change in the interference fringes in the light transmitted through the first optical element can be further increased. Therefore, it is possible to make it more difficult to visually recognize the interference fringes.

### Appendix 6

The light source device according to any one of Appendices 1 to 5, wherein

the light source unit includes a laser light emitting element.

According to this configuration, the light source unit can emit high-luminance light.

### Appendix 7

The light source device according to any one of Appendices 1 to 6, further including

a moving unit configured to move the first optical element, wherein

the moving unit is a voice coil motor.

According to this configuration, the first optical element can be smoothly swung in the uniaxial direction with the voice coil motor.

### Appendix 8

The light source device according to Appendix 2, wherein

the first optical element includes a third lens group including a plurality of third lenses having a third curvature, and a fourth lens group including a plurality of fourth lenses having a fourth curvature different from the third curvature,

the third lens group and the fourth lens group are arranged side by side in a direction orthogonal to the first axis and the optical axis, and

an arrangement pitch of the plurality of third lenses of the third lens group is different from an arrangement pitch of the plurality of fourth lenses of the fourth lens group.

According to this configuration, since the third lens group and the fourth lens group have the respective arrangement pitches different from each other, interference fringes by the third lens group and interference fringes by the fourth lens group are different from each other. Therefore, by increasing the degree of temporal change of the interference fringes of the light transmitted through the first optical element, the interference fringes in the illumination light can be made more difficult to visually recognize. Further, the first optical element can be easily manufactured by bonding the third lens group and the fourth lens group to each other.

### Appendix 9

The light source device according to Appendix 1 or 2, further including

a substrate provided with the first optical element, and

a drive unit configured to rotate the substrate around a center of the substrate as a rotational axis.

According to this configuration, the first optical element can be moved in a plane perpendicular to the optical axis by rotating the substrate.

### Appendix 10

The light source device according to Appendix 9, wherein

the substrate is a disk, and

the first optical element is disposed annularly along a circumferential direction of the substrate.

According to this configuration, the first optical element can be moved in the circumferential direction of the substrate in the plane orthogonal to the optical axis. Accordingly, since the position at which the light emitted from the light source unit is transmitted through the first optical element temporally changes, it is possible to temporally change the interference fringes in the light. This makes it difficult to visually recognize the interference fringes by time-averaging the interference fringes in the illumination light.

### Appendix 11

The light source device according to Appendix 10, wherein

the first optical element is disposed closer to an outer peripheral edge of the substrate than to a midpoint between a center of the substrate and the outer peripheral edge in a radial direction of the substrate.

According to this configuration, since the curvature of the first optical element can be increased, the distortion generated in the light transmitted through the first optical element can be reduced. Therefore, it is possible to favorably generate the illumination light shaped like a band extending in the first axis direction while suppressing the distortion.

### Appendix 12

The light source device according to any one of Appendices 1 to 11, further including

a light scanning unit configured to perform scanning with the illumination light incident from the second optical element in a direction orthogonal to the first axis and the optical axis.

According to this configuration, it is possible to scan the illumination target area with the illumination light shaped like a band using the light scanning unit. The illumination light extends in a band shape in a direction orthogonal to the light scanning direction by the light scanning unit. Therefore, the light scanning unit can efficiently illuminate the rectangular illumination target area with the illumination light shaped like a band.

### Appendix 13

A projector including

the light source device according to any one of Appendices 1 to 12,

a light modulation device configured to modulate light output from the light source device in accordance with image information, and

a projection optical device configured to project the light modulated by the light modulation device.

According to the projector having this configuration, since the illumination light emitted from the light source device efficiently illuminates the light modulation device, it is possible to project a bright image. Further, it is possible to project a high-quality image in which interference fringes and speckle noise in the projection image are suppressed.

What is claimed is:

1. A light source device comprising:
a light source unit;
a first optical element configured to diffuse light emitted from the light source unit along a first axis orthogonal to an optical axis of the light to generate illumination light shaped like a band extending along the first axis; and
a second optical element configured to collimate the illumination light emitted from the first optical element in a direction along the first axis, wherein
the first optical element moves in a plane perpendicular to the optical axis.

2. The light source device according to claim 1, wherein
the first optical element is a lenticular lens.

3. The light source device according to claim 2, wherein
the first optical element includes a first lens group including a plurality of first lenses having a first curvature, and a second lens group including a plurality of second lenses having a second curvature different from the first curvature,
the first lens group and the second lens group are disposed in a direction along the first axis, and
an arrangement pitch of the plurality of first lenses of the first lens group is different from an arrangement pitch of the plurality of second lenses of the second lens group.

4. The light source device according to claim 1, wherein
the first optical element also diffuses the light emitted from the light source unit in a direction along a second axis orthogonal to the first axis,
the first optical element has a first diffusion angle along the first axis and a second diffusion angle along the second axis, and
the second diffusion angle is smaller than the first diffusion angle.

5. The light source device according to claim 4, wherein
the first optical element moves in two directions respectively along the first axis and the second axis.

6. The light source device according to claim 1, wherein
the light source unit includes a laser light emitting element.

7. The light source device according to claim 1, further comprising:
a moving unit configured to move the first optical element, wherein
the moving unit is a voice coil motor.

8. The light source device according to claim 2, wherein
the first optical element includes a third lens group including a plurality of third lenses having a third curvature, and a fourth lens group including a plurality of fourth lenses having a fourth curvature different from the third curvature,
the third lens group and the fourth lens group are arranged side by side in a direction orthogonal to the first axis and the optical axis, and
an arrangement pitch of the plurality of third lenses of the third lens group is different from an arrangement pitch of the plurality of fourth lenses of the fourth lens group.

9. The light source device according to claim 1, further comprising:
a substrate provided with the first optical element; and
a drive unit configured to rotate the substrate around a center of the substrate as a rotational axis.

10. The light source device according to claim 9, wherein
the substrate is a disk, and
the first optical element is disposed annularly along a circumferential direction of the substrate.

11. The light source device according to claim 10, wherein
the first optical element is disposed closer to an outer peripheral edge of the substrate than to a midpoint between a center of the substrate and the outer peripheral edge in a radial direction of the substrate.

12. The light source device according to claim 1, further comprising:
a light scanning unit configured to perform scanning with the illumination light incident from the second optical element in a direction orthogonal to the first axis and the optical axis.

13. A projector comprising:
the light source device according to claim 1;
a light modulation device configured to modulate the light incident from the light source device in accordance with image information; and
a projection optical device configured to project the light modulated by the light modulation device.
